(19) United States
(12) Patent Application Publication
(10) Pub. No.: US 2026/0043203 A1
(43) Pub. Date: Feb. 12, 2026

(54) BARRIER ARM OPERATOR

(71) Applicant: THE CHAMBERLAIN GROUP LLC, OAK BROOK, IL (US)

(72) Inventors: Weixiong Chen, Naperville, IL (US); Jorge Castrejon Atonal, Tlahuac (MX)

(21) Appl. No.: 19/005,252

(22) Filed: Dec. 30, 2024

Related U.S. Application Data
(60) Provisional application No. 63/681,514, filed on Aug. 9, 2024.

(51) Int. Cl. E01F 13/06; E05F 15/603

(52) U.S. Cl. CPC E01F 13/06; E05F 15/603; E05Y 2400/44; E05Y 2900/402

(57) ABSTRACT

A movable barrier assembly including a barrier arm operator including: a housing; a driving mechanism supported by the housing; and a bracket coupled to the driving mechanism and driven to rotate about a rotational axis by the driving mechanism; a multi-segmented arm assembly movable between a lowered position and a raised position, the multi-segmented arm assembly including: a first arm segment coupled to the bracket; and a second arm segment coupled to the first arm segment at an articulation; and a forcing rod assembly that passively articulates the first arm segment relative to the second arm segment in response to rotation of the driving mechanism, wherein the forcing rod assembly is disposed at a vertical elevation below the arm when the arm is in the lowered position.

### CROSS-REFERENCE TO RELATED APPLICATIONS

The present application claims priority to U.S. provisional patent application Ser. No. 63/681,514 filed on Aug. 9, 2024, the disclosure of which is incorporated by reference herein in its entirety.

### FIELD

This disclosure relates to movable barrier operators and movable barrier assemblies and, more specifically, to movable barrier arm operators and movable barrier arm assemblies.

### BACKGROUND

Barrier arm operators are often used to control access to secured areas, such as parking lots, parking structures, and gated communities. Barrier arm operators typically include a barrier that is selectively movable between open and closed positions to facilitate selective access to the secured area. One problem with barrier arm operators is that if the barrier arm of the barrier arm operator is struck by a vehicle, the barrier arm may need to be reattached if substantially undamaged or replaced if damaged.

Accordingly, improved barrier arms that allow for breakaway and resetting in response to vehicle impact are desired in the art.

### BRIEF DESCRIPTION

Aspects and advantages of the invention in accordance with the present disclosure will be set forth in part in the following description, or may be obvious from the description, or may be learned through practice of the technology.

In accordance with one embodiment, a movable barrier assembly is provided. The movable barrier assembly includes a barrier arm operator comprising: a housing; a driving mechanism supported by the housing; and a bracket coupled to the driving mechanism and driven to rotate about a rotational axis by the driving mechanism; a multi-segmented arm assembly movable between a lowered position and a raised position, the multi-segmented arm assembly comprising: a first arm segment coupled to the bracket; and a second arm segment coupled to the first arm segment at an articulation; and a forcing rod assembly that passively articulates the first arm segment relative to the second arm segment in response to rotation of the driving mechanism, wherein the forcing rod assembly is disposed at a vertical elevation below the arm when the arm is in the lowered position.

In accordance with another embodiment, a movable barrier assembly is provided. The movable barrier assembly includes an operator comprising: a driving mechanism; and a bracket operably coupled to the driving mechanism, wherein the driving mechanism rotates the bracket about a rotational axis in a first direction and a second direction opposite the first direction; an arm coupled to the bracket and driven between a lowered position and a raised position by rotation of the bracket about the rotational axis, wherein the arm comprises: a first arm segment coupled to the bracket; and a second arm segment coupled to the first arm segment; and a forcing rod assembly coupled to the operator and coupled to the arm at a vertical elevation below the arm when the arm is in the lowered position, wherein the forcing rod assembly articulates the second arm segment relative to the first arm segment in response to the bracket rotating about the rotational axis, wherein the arm is rotatably coupled to the bracket about a pivot axis, and wherein the arm rotates about the pivot axis in response to impact from an object against the arm.

In accordance with another embodiment, a movable barrier arm assembly is provided. The movable barrier arm assembly includes a multi-segmented arm assembly configured to move between a raised position and a lowered position, the multi-segmented arm assembly comprising: a first arm segment; and a second arm segment coupled to the first arm segment at an articulation; and a forcing rod assembly configured to passively articulate the first arm segment relative to the second arm segment in response to the first arm segment being rotationally driven about a rotational axis by a driving mechanism of a barrier arm operator, wherein the forcing rod assembly is disposed at a vertical elevation below the multi-segmented arm assembly when the multi-segmented arm assembly is in the lowered position.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

FIG. 1 is an elevation view of an example barrier arm operator with an arm in a lowered position to limit access to a secured area;

FIG. 2 is a top view of the example barrier arm operator of FIG. 1 with the arm in a first position associated with a non-breakaway position and a second position associated with a breakaway position;

FIG. 3 is a perspective view of a bracket for use with the example barrier arm operator of FIG. 1 to support a breakaway arm;

FIG. 4 is a perspective view of a portion of the example barrier arm operator of FIG. 1 as seen without the bracket of FIG. 3 and with a portion of a forcing rod assembly moving to the second position;

FIG. 5 is an enlarged perspective view of a portion of the barrier arm operator of FIG. 1 as seen in the first position; and

FIG. 6 is a flowchart of a method of using a barrier arm operator in accordance with an example embodiment.

### DETAILED DESCRIPTION

The embodiments set forth below represent the information to enable individuals to practice the embodiments. Upon reading the following description in light of the accompanying figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first axis” and “second axis,” and does not imply an initial occurrence, a quantity, a priority, a type, an importance, or other attribute, unless otherwise stated herein. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B.

Movable barrier assemblies generally include a movable barrier operator and a movable barrier. The movable barrier operator is generally used to move one or more movable barriers between two or more relative positions, such as an open position and a closed position. The movable barrier operator can include a barrier arm operator and the movable barrier can include an arm. The barrier arm operator can rotate the arm between a first position and a second position. In some implementations, movement between the first and second positions is automatically performed. For example, the movable barrier assembly can further include a sensor (e.g., a photo eye, a weight sensor, a camera, a near-field communication component, or the like) that detects presence of an authorized entity. When the authorized entity is present, the barrier arm operator can adjust the arm to permit entrance of the authorized entry. Conversely, when either no entity is present or a non-authorized entity is present, the barrier arm operator can retain the arm in the closed position, preventing access to the secured area. In other implementations, movement of the arm between the first and second positions can be manually activated. For example, a security guard or other onsite personnel can interact with a user interface in response to manually verifying credentials of a nearby entity. The user interface communicates with the barrier arm operator to move the arm accordingly.

Barrier arm operators described herein generally include a driving mechanism (referred to as the drive) configured to move an arm or arm assembly between restrictive (closed) and permissive (open) positions to facilitate selective access to the secured area at least partially bounded by the arm or arm assembly. In general, barrier arm assemblies provided herein allow for enhanced control of the arm or arm assembly. The arm assembly can include a plurality of arm segments movably coupled (articulated) together, for example, at a hinged interface. A proximal end of a first arm segment is rotatably coupled to a housing of the barrier arm operator and rotatable about a first rotational axis. A second arm segment is rotatably coupled to a distal end of the first arm segment and can be rotatable about a second rotational axis oriented parallel, or generally parallel, with the first rotational axis. The arm assembly, and more particularly the first arm segment, is coupled to a bracket. The bracket is supported by the housing of the barrier arm operator and is rotationally moved by the drive (e.g., an electric motor) of the barrier arm operator about the first rotational axis. The arm assembly moves between the open and closed positions in response to the drive repositioning (rotating) the bracket.

The movable barrier assembly further includes a forcing rod assembly disposed at a vertical elevation below the arm assembly at least when the arm assembly is in a lowered (closed, restrictive) position. The forcing rod assembly is coupled to the housing of the barrier arm operator through a mount. By way of example, the mount can include a pin, shaft, bushing, or the like that provides a rotational interface for the forcing rod assembly. The mount is located below the bracket that supports the first arm segment. This may be referred to as an underhand operator, or an underhand-mounted forcing rod assembly. A first end of the forcing rod assembly is rotatably coupled to the housing of the operator through the mount about a rotational axis oriented generally parallel to the rotational axis of the bracket. A second end of the forcing rod assembly is coupled to the second arm segment. The forcing rod assembly may not be directly coupled to the first arm segment and instead connect indirectly to the first arm segment through the second arm segment. By way of example, the second end of the forcing rod assembly can be coupled to a proximal end of the second arm segment, e.g., adjacent to the location of articulation between the first and second arm segments. The forcing rod assembly can affect articulation between the first and second arm segments as the drive rotates the bracket. In particular, the forcing rod assembly can cause the second arm segment to articulate relative to the first arm segment in response to movement of the bracket. In some instances, the forcing rod assembly can be tuned (e.g., a length of the forcing rod assembly can be adjusted) such that the second arm segment remains in a horizontal, or generally horizontal, orientation as the bracket is rotated about the first rotational axis. The forcing rod assembly can remain parallel with the first arm segment as the arm assembly moves from the lowered position to a raised position and/or from the raised position to the lowered position. In some implementations, the forcing rod assembly can be parallel with the first arm segment in the raised position and in the lowered position.

Movable barrier assemblies described herein can be installed at locations with overhead restrictions, i.e., overhead clearance issues, without compromising vehicle clearance. Assuming a flat surface, maximum vehicle clearance height is largely determined by a relative distance between the ground and a lowest part of the barrier arm overhanging the vehicle as it passes through the movable barrier assembly. The lower the barrier arm, the less the maximum vehicle clearance height. Meanwhile, overhead restrictions such as tree branches, garage overhangs, overlying structure, signage, and the like can restrict the maximum height that the barrier arm can open in the upward direction. Traditional barrier arms are single-member rigid structures which rotate 90 degrees between horizontal and vertical positions. Where overhead restrictions are present, the barrier arm length is limited by the overhead restriction. To increase vehicle clearance height without compromising on barrier arm length, the barrier arm is formed in a multi-segmented arm assembly as described herein which permits relative movement between segments to accommodate overhead restrictions. To further maximum vehicle clearance height, embodiments described herein position the forcing rod assembly entirely below the uppermost portion of the multi-segmented arm assembly. In this regard, the multi-segmented arm assembly can be raised closer to the overhead restriction and the maximum vehicle clearance height is increased. Yet further, positioning the forcing rod assembly at a relatively lower height permits a technician to more easily reach the forcing rod assembly in the event of maintenance or repair.

During routine use, it is not uncommon for the arm assembly to be impacted, e.g., by a vehicle, flying debris, a human or animal, or another potentially damaging force. Traditionally, impacted barrier arms require full replacement. However, the barrier arm assemblies described herein permit the arm assembly to move from a first (engaged) position to a second (breakaway) position in response to impact. Movement of the arm assembly from the first to second position may include rotation of the arm assembly about a pivot axis. The pivot axis can be oriented in a vertical, or generally vertical, direction. Thus, movement of the arm assembly to the second position can include rotation of the arm assembly about a vertical pivot axis. In the first (engaged) position, the arm assembly restricts access to the secured area. In the second (breakaway) position, the arm assembly does not fully prevent access to the secured area.

Movement between the first and second positions includes movement of both the arm assembly and the forcing rod assembly. That is, the arm assembly and the forcing rod assembly move together when impacted. As a result, the forcing rod assembly can maintain the second arm segment in a relatively same, or similar, position and orientation with respect to the first arm segment in both the engaged position and the breakaway position. That is, the second arm segment does not sag as a result of the breakaway. Instead, the forcing rod assembly maintains the second arm assembly in the operating (horizontal) state.

Where breakaway occurs while the arm assembly is moving from the first (closed) position to the second (open) position or vice versa, i.e., the arm assembly is impacted during transition between the closed and open positions, the forcing rod assembly can maintain the first and second arm segments in their current relative orientations with respect to one another. In some instances, the drive may return the bracket to the first position in response to detecting impact. In other instances, the drive may continue moving the bracket to the second position even after impact is detected.

The movable barrier assembly can include an orientation-maintaining component that maintains the forcing rod assembly substantially parallel to the first arm segment when the arm rotates about the pivot axis. The orientation-maintaining component can include a flange (or other feature) coupled to the forcing rod assembly. The orientation-maintaining component can extend towards the arm assembly. In the engaged position, i.e., prior to breakaway, the orientation-maintaining component may not contact and/or support the arm assembly. Upon breakaway, the orientation-maintaining component can come to rest against the arm assembly, such as against the first arm segment, such that the orientation-maintaining component forms an interface between the arm assembly and the forcing rod assembly, creating a parallel, or substantially parallel, relationship therebetween. The orientation-maintaining component can thus prevent the second arm segment from sagging at the articulation with the first arm segment upon a breakaway condition.

Due to the movement of the arm assembly from the first position to the second position about the vertical pivot axis in response to impact, damage to the arm assembly is largely mitigated, allowing the arm assembly to be easily reset. An onsite worker, an on-call technician, or the like can reset the arm assembly and the forcing rod assembly from the breakaway position to the engaged position by applying force to the arm assembly, the forcing rod assembly, or both. The applied force can be oriented opposite the direction of the breakaway movement. The applied force causes the arm assembly and the forcing rod assembly to rotate about the pivot axis. The arm assembly is rotated until it reaches the engaged position. In some implementations, the first arm segment can snap into the bracket to lock the arm assembly in the engaged position. The person performing the reset operation may receive a confirmation of positive engagement between the first arm segment and the bracket, for example, in the form of a tactile indication, an audible indication, or the like. No further action is required once the arm assembly is reset to the engaged position by fully rotating the arm assembly to the engaged position. The movable barrier assembly can thus resume normal activity, allowing the bracket to rotate the arm assembly between the first and second positions.

In an embodiment, the arm assembly and forcing rod assembly described herein can be retrofit to an existing barrier arm operator that does not already utilize an underhand-mounted forcing rod assembly. One or more components of the existing barrier arm operator can be replaced to accommodate the new underhand-mounted forcing rod assembly. This may include, for example, attaching the mount to the housing, attaching the forcing rod to the mount, and attaching the forcing rod to the arm assembly. Where the previous arm assembly is a single rigid member, the retrofitting can further include replacing the rigid member with a multi-segmented arm assembly. Where the previous arm assembly is already a multi-segmented arm assembly, the retrofitting operation can include attaching the newly positioned forcing rod assembly to the second arm segment from an underside of the second arm segment. The relative length of the forcing rod assembly can be tuned to affect an orientation of the second arm segment when the barrier arm assembly is in the closed and/or open positions.

The retrofittable arm assembly can include a kit formed from the multi-segmented arm assembly, the forcing rod assembly, and optionally, one or both of the bracket and/or the mount. In some implementations, the kit is pre-assembled, or at least partially pre-assembled. For example, the first and second arm segments can be coupled together. The first and second arm segments can be rotated to a storage position whereby the second arm segment is rotated 180 degrees about the articulated junction such that the first and second arm segments are disposed immediately adjacent to one another. In some instances, the forcing rod assembly, or a portion thereof, can be preconnected to the second arm segment. To retrofit the pre-assembled kit, the second arm segment is rotated towards the open direction and the first arm segment is coupled to the operator through the bracket (or an existing bracket if applicable). The forcing rod assembly is coupled to the mount. The arm assembly is then ready to be utilized for access control to the secured area.

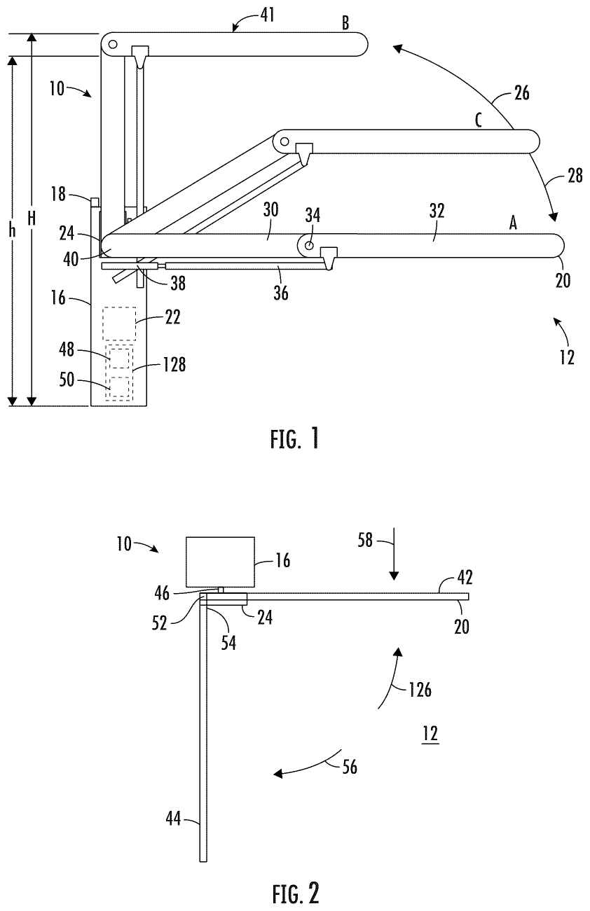

Regarding FIG. 1, a barrier arm operator 10 is provided for limiting access to a secured area 12 and may be positioned along, for example, a driveway or road, that leads to a parking lot or other type of secured area 12. FIG. 1 illustrates a side view of the barrier arm operator 10 as seen from the secured area 12. In accordance with another embodiment, the barrier arm operator 10 may appear the same as illustrated in FIG. 1 from the other side, i.e., the opposite side from the secured area 12.

The barrier arm operator 10 (hereinafter “the operator 10”) includes a housing 16 and may optionally include an indicator light 18 that may illuminate different colors to identify different operator events, such as illuminating red when an arm 20 of the operator 10 is in a lowered position A and illuminating green when the arm 20 is in a raised position B. The operator 10 has a driving mechanism (hereinafter referred to as “the drive 22”) that is connected to the arm 20 via a bracket 24. For clarity, the bracket 24 is only depicted in the raised position B, however the bracket 24 rotates the arm 20 and is thus reoriented by the drive 22 between a first rotational position corresponding to the lowered position A and a second rotational position corresponding to the raised position B. The drive 22 can include, for example, an electric motor. The drive 22 is operable to turn, pivot, rotate or otherwise move the bracket 24 in a direction 26 to raise the arm 20 from a substantially horizontal orientation to an upright substantially vertical orientation and then subsequently turn, pivot, rotate or otherwise move the bracket in a second direction 28 (the second direction opposite to the first direction) to move the arm 20 back to the substantially horizontal orientation. The arm 20 passes through an intermediate position C when travelling between the lowered position A and the raised position B. In some instances, the arm 20 can pass through the intermediate position C without stopping. In other instances, the arm 20 can be stopped at the intermediate position C (or any other intermediate position between the lowered position A and the raised position B).

The arm 20 includes a multi-segmented arm assembly including, for example, a first arm segment 30 and a second arm segment 32. The first and second arm segments 30 and 32 are movably coupled together at an articulation 34. The articulation 34 can be formed by a pinned interface optionally including a bearing or other low friction interface that permits relative movement between the first and second arm segments 30 and 32. The first and second arm segments 30 and 32 can pivot relative to one another about the articulation 34. For example, the first and second arm segments 30 and 32 can be generally parallel with one another when the arm 20 is in the lowered position A and generally perpendicular with one another when the arm 20 is in the raised position B. In one or more embodiments, a pivot axis between the first and second arm segments 30 and 32 at the articulation 34 can be oriented in a plane that is generally perpendicular to the directions 26, 28. For example, the pivot axis at the articulation 34 can be oriented in a generally horizontal plane. The pivot axis may be oriented parallel to the rotational axis of the bracket 24.

Relative articulation between the first and second arm segments 30 and 32 is caused by a forcing rod assembly 36. The forcing rod assembly 36 can cause relative movement between the first and second arm segments 30 and 32 at the articulation 34 as a result of the drive 22 rotating the bracket 24. The forcing rod assembly 36 can passively articulate the first and second arm segments 30 and 32 relative to one another. As used herein, “passively articulate” is intended to refer to an interaction which is not directly caused by introducing motive force from the article causing the movement. That is, for example the articulation between the first and second arm segments 30 and 32 is caused by movement of the drive 22 (and resulting movement of the bracket 24) with passive, constraining force introduced by the forcing rod assembly 36 to affect articulation. The forcing rod assembly 36 does not include independent motive power and instead constrains movement of the second arm segment 32 to cause articulation between the first and second arm segments 30 and 32 as a result of rotation of the bracket 24.

A length of the forcing rod assembly 36 can be adjustable. Adjusting the length of the forcing rod assembly 36 permits adjustment to the angular orientation of the arm 20 or one or more segments thereof. For example, the length of the forcing rod assembly 36 can be reduced to articulate a distal (far) end of the second arm segment 32 downward from the articulation 34. Alternatively, the length of the forcing rod assembly 36 can be increased to articulate the distal (far) end of the second arm segment 32 upward from the articulation 34. An installation technician may set the length of the forcing rod assembly 36 during commissioning, e.g., by moving the arm 20 to the lowered position 20 and adjusting the length of the forcing rod assembly 36 until the second arm segment 32 is disposed parallel with a horizontal plane or some other desirable orientation. The arm 20 (and more particularly, the second arm segment 32) remains in the desired orientation(s) in the lowered and raised positions A, B once the length of the forcing rod assembly 36 is set.

The forcing rod assembly 36 can be oriented parallel with respect to the first arm segment 30 when the arm 20 is in at least one of the lowered position A, the raised position B, and/or the intermediate position C. The forcing rod assembly 36 can be oriented parallel to the first arm segment 30 when the arm 20 is in both the lowered position A and the raised position B. In an embodiment, the forcing rod assembly 36 can remain parallel to the first arm segment 30 at all times, i.e., at all relative angular positions of the first arm segment 30 between and including the lowered position A and the raised position B. Parallel orientation of the forcing rod assembly 36 with respect to the first arm segment 30 can reduce the amount of force required to move the arm 20 between the lowered position A and the raised position B. Moreover, parallel orientation between the forcing rod assembly 36 and the first arm segment 30 can reduce eccentric loading at a rotational axis 38 of the forcing rod assembly 36 as the bracket 24 is driven about a rotational axis 40 of the bracket 24. In this regard, the operator 10 can have prolonged lifespan and reduced power requirements to raise and lower the arm 20.

As described above, the forcing rod assembly 36 is disposed below the arm 20. The operator 10 may thus be referred to as an underhand operator, meaning the forcing rod assembly 36 is disposed below the arm 20 when the arm 20 is in at least the lowered position A. Underhand operators cause the forcing rod assembly 36 to operate in compression to support the weight of the arm 20. To the contrary, overhand operators utilize an upper assembly to support the weight of the arm in a state of tension.

During use, the operator 10 moves the arm 20 between the lowered position A and the raised position B, e.g., in response to access authorization. In the raised position, an uppermost point or surface of the assembly is defined by the arm 20, and more particularly, by an upper surface 41 or point location of the second arm segment 32. The uppermost point that the assembly extends in the raised position, and thus a maximum clearance height H required to run the operator 10, is thus defined by the upper surface 41 of the arm 20. Conversely, overhand operators include additional upper hardware which extends (projects) above the upper surface 41 of the arm 20 in the raised position B. As such, overhand operators require additional clearance height H to run and avoid impacting overhanging objects such as the ceiling of a parking structure while providing the same vehicle clearance height. As a result, vehicle clearance h is greater in the underhand operator 10 described herein as compared to an overhand operator.

The operator 10 can allow for a breakaway condition to occur when the arm 20 is impacted, e.g., by a person or a vehicle. In response to impact, the arm 20 can move within a horizontal plane (about a vertical pivot axis) from a first position (as shown in FIG. 1) to a second position angularly offset from the first position as shown in FIG. 2.

FIG. 2 is a top view of the operator 10, depicting the arm 20 in the first position 42 and the second position 44. In the first position 42, the arm 20 restricts access to the secured area 12. In particular, when the arm 20 is in the lowered position A (FIG. 1) and the first position 42 (FIG. 2), entry to the secured area 12 is restricted. As a result, entities (such as vehicles) approaching the operator 10 are required to present access authorization to raise the arm 20 to the raised position B (FIG. 1). Access authorization can include manual authorization, such as for example a security guard stationed at the operator 10 can manually verify authorization and selectively grant access in response to verified authorization. Access authorization can also, or alternatively, include automatic or semi-automatic authorization, such as for example, scanning a barcode, using a near field communication element (e.g., Bluetooth, UWB, etc.) to verify authorized access, or the like. In response to verifying authorized access, the operator 10 can raise the arm 20 from the lowered position A to the raised position B to permit entrance into the secured area 12.

In some instances, the arm 20 may be contacted prior to reaching the raised position B (FIG. 1). For example, a vehicle approaching the operator 10 may not slow down sufficiently to allow the arm 20 to reach the raised position B (FIG. 1). As a result, the vehicle can impact the arm 20. Alternatively, a vehicle without access authorization may run through the arm 20 in an attempt to gain unpermitted access to the secured area 12. Yet further, a pedestrian or animal may walk into the arm 20 or an object can collide with the arm 20. All of these instances can result in damage to the operator 10 or arm 20 in the case where the arm 20 is pinned to (not movable with respect to) the bracket 24. In some cases, damage may be limited to a bent or dented arm 20. In other cases, the force on the arm 20 can damage the bracket 24, an axle 46 supporting the bracket 24, the drive 22, the housing 16, control circuitry (such as a processor 48 or a memory storage device 50 as depicted in FIG. 1), and/or other components associated with the operator 10.

In one or more embodiments the arm 20 can form a breakaway connection with the bracket 24 to limit damage upon impact. The operator 10 can include a pivot connection 52 between the arm 20 and the bracket 24 that permits the arm 20, particularly a distal end 54 of arm 20, to pivot in direction 56 in response to a force such as a person moving the arm 20 or a vehicle or other object striking the arm 20 in direction 58. The impact of the vehicle in the direction 58 causes the arm 20 to move from the first position 42 to the second position 44. The pivot connection 52 may be in the form of a pin, shaft, bushing, or the like which permits relative movement of the arm 20 with respect to the operator 10 about a vertical axis.

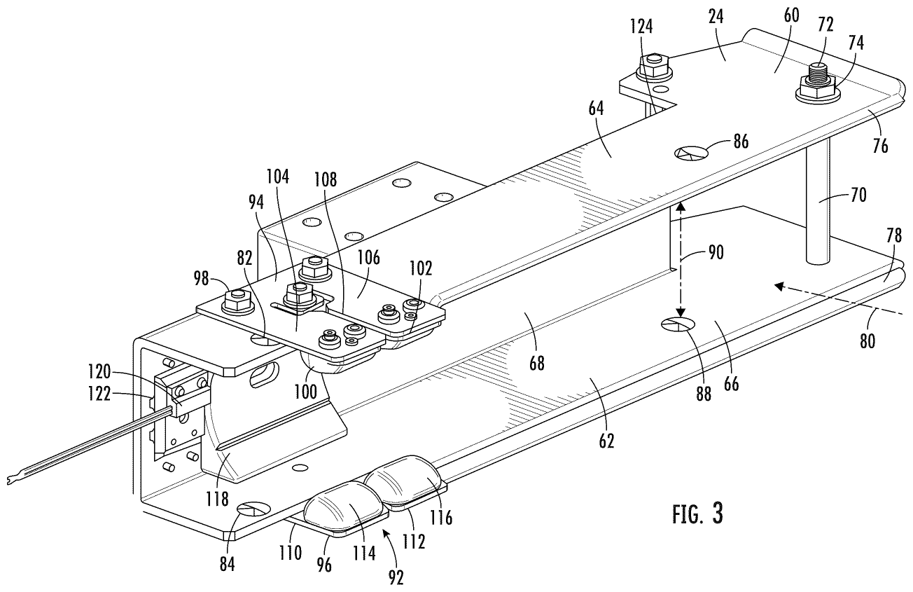

Regarding FIG. 3, the bracket 24 can include a body 60 with a channel 62, which is generally C-shaped in cross section, to receive the arm 20 therein. The body 60 has upper and lower plate portions 64, 66 and a wall portion or web 68 therebetween. The bracket 24 has a mounting portion 150 connected to the web 68 and configured to be secured to the axle 46 (see FIG. 2) of the operator 10. The pivot connection 52 between the arm 20 and the bracket 24 (FIG. 2) includes a pivot shaft, such as a pin, rod, or sleeve 70 that extends between the upper and lower plate portions 64, 66 and may be secured in position via, for example, a threaded portion or bolt 72 and a fastener 74. The upper and lower plate portions 64, 66 have lips 76, 78 that are tapered or chamfered relative to the upper and lower plate portions 64, 66 to redirect the arm 20 into the channel 62 as the arm 20 pivots in direction 80. The upper and lower plate portions 64, 66 have pairs of bumps 82, 84 and 86, 88 in the outer surfaces such that an opposite side of the bumps 82, 84 and 86, 88 project slightly into the channel 62. The innermost portions of the bumps 82, 84 and 86, 88 are each separated by a distance 90 that is approximately the maximum height of the arm 20 received in the channel 62 to limit up-and-down, rattling movement of the arm in the channel 62.

The bracket 24 further includes a detent 92 including upper and lower spring plates 94, 96 that are secured to the upper and lower plate portions 64, 66 via one or more fasteners 98. The detent 91 includes upper lugs 100, 102 that are secured to arm portions 104, 106 of the spring plate 94. The spring plate 94 has one or more through openings, such as a Y shaped slot 108 formed therein to increase the flexibility of the arm portions 104, 106. The Y shaped slot 108 allows arm portions 104, 106 to pivot independently relative to one another as the arm 20 engages and disengages from the bracket 24. The spring plate 96 has a similar configuration with arm portions 110, 112 that support lower lugs 114, 116. The upper and lower spring plates 94, 96 may be made of a metallic material such as stainless steel. The upper lugs 100, 102 and lower lugs 114, 116 may be made of a polymeric material, such as a high strength, low friction elastic material such as Delrin® or the like with high durability, wear-resistance and inherent lubricity. An adapter 118 is releasably connected to the web 68 and is shaped to cooperate with or otherwise complement an outer profile of the body of the arm 20, which may rectangular or cylindrical. The adapter 118 may also be made of a polymeric material, which may be the same material or different material from the aforementioned lugs. A detector, such as a hall effect sensor 120, may be received in an opening 122 of the web 68. The bracket 24 has a stop, such as a bolt 124, that is configured to limit pivoting of the arm 20 as the arm pivots in direction 56 (see FIG. 2) due to an impact from a vehicle.

The lugs 100, 102 and 114, 116 form a pocket for receiving the arm 20. When the arm 20 is urged out of the pocket in direction 56 (FIG. 2) due to an impact from an object or a vehicle, a leading surface of the arm 20 engages an inner surface portion of each of the lugs 100, 102 and 114, 116 and urges the upper lugs 100, 102 upwards as well as urges the lower lugs 114, 116 downwards. In other words, the impact from a vehicle or object urges the upper and lower lugs 100, 102 and 114, 116 apart to enlarge a distance between the upper and lower lugs 100, 102 and 114, 116, which permits the arm 20 to disengage from the bracket 24 in direction 56. The arm portions 104, 106 resiliently urge the upper and lower lugs 100, 102 back together with the upper and lower lugs 114, 116 to an initial configuration. The upper and lower lugs 100, 102 and 114, 116 can have a curved outer surface with a compound radius. Specifically, the curved outer surface has an inner surface portion with a first radius and an outer surface portion with a second radius that is larger than the first radius. The first radius is selected to provide enough resistance to movement of the arm 20 within the pocket and engaged with the bracket 24. The inner surface portion has a plane extending at an angle, such as approximately 110 degrees, relative to the associated spring plate 92, 94.

FIG. 4 illustrates a portion of the forcing rod assembly 36 coupled to the housing 16 of the operator 10. The arm 20 is omitted from FIG. 4 for clarity. The forcing rod assembly 36 is rotatably coupled to the housing 16 through a mount 130. The mount 130 can be coupled to the housing 16, e.g., using one or more fasteners, adhesives or the like. In some implementations, the mount 130 may be integral with the housing 16, formed from a single piece of material. The mount 130 can provide a rotational interface 132 for rotatably receiving the forcing rod assembly 36. As the arm 20 is raised and lowered about the axle 46 (see, e.g., FIG. 1), the forcing rod assembly 36 rotates about an axis 134 extending through the rotational interface 132. In particular, as the arm 20 is raised, the forcing rod assembly 36 is caused to rotate in a direction 136 about the axis 134. Conversely, as the arm 20 is lowered, the forcing rod assembly 36 is caused to rotate in a direction 138 about the axis 134 opposite the direction 136.

The forcing rod assembly 36 can include at least two separate components. In particular, the forcing rod assembly 36 can include a first member 140 and a second member 142. The first member 140 can be rotationally coupled to the mount 130 and movable only in a rotational direction about the axis 134. The second member 142 can be coupled to the first member 140 (directly or indirectly) and move relative to the first member 140. For example, the second member 142 can be rotatably coupled to the first member 140 about an axis 144 angularly offset from the axis 134, such as perpendicular to the axis 134. During a breakaway condition, the second member 142 pivots relative to the first member 140 about the axis 144 in a direction 146. In this regard, force to the arm 20 caused by impact is transmitted to the forcing rod assembly 36 which allows for breakaway by allowing relative movement of the second member 142 with respect to the first member 140 about the axis 144.

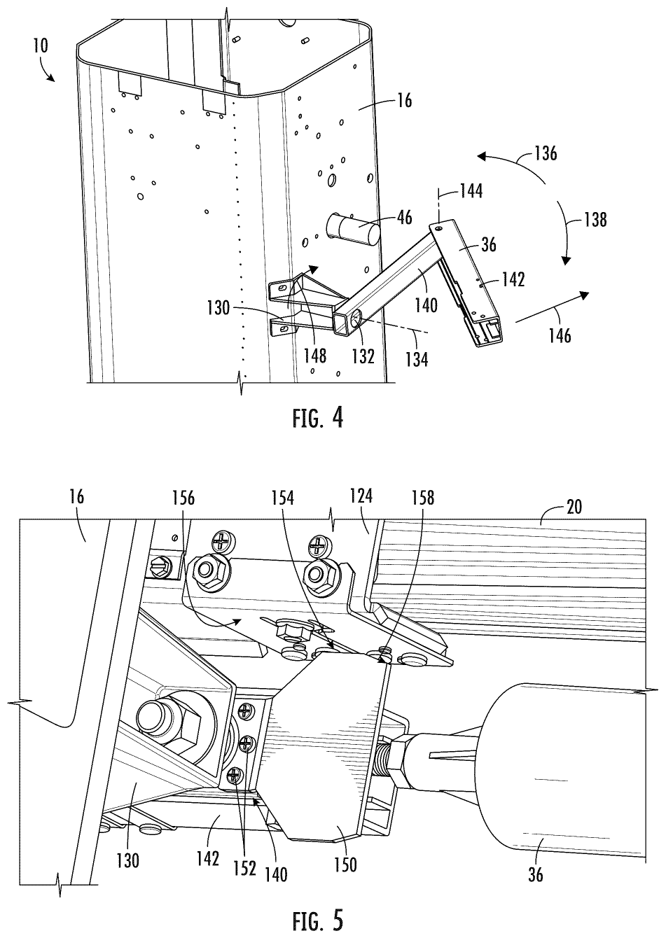

The rotational interface 132 may allow the first member 140 to rotate about the axis 134 in a direction 148 if left unsupported in the breakaway condition. To prevent rotation about the axis 134 in the direction 148 during a breakaway condition, an orientation-maintaining component 150 can be introduced (FIG. 5).

Referring to FIG. 5, the orientation-maintaining component 150 can be coupled to the forcing rod assembly 36, e.g., by one or more fasteners 152. The orientation-maintaining component 150 can be coupled to the first member 140 and extend in a vertical direction to a location above the first member 140 in the assembled state such that an upper surface 154 of the orientation-maintaining component 150 can interact with a lower surface 156 of the bracket 124 or another component of the operator 10 or arm 20. When the arm 20 is in a breakaway condition, eccentric weight from the arm 20 and second member 142 can be transferred through the first member 140 to the orientation-maintaining component 150 which can bear against the lower surface 156 of the bracket 124 (or the lower surface of the arm 20) to prevent the first member 140 from sagging. However, when the arm 20 is in the lowered position A (FIG. 1) and not in a breakaway condition, i.e., the arm 20 is properly seated within the bracket 24 for normal operation, the orientation-maintaining component 150 may not bear against the lower surface 156 or only minimally bear against the lower surface 156. When the arm 20 is rotated to the raised position B (and/or anytime the arm 20 is in a position other than the lowered position A), the orientation-maintaining component 150 may not bear load against the bracket 24 and may be spaced apart from the bracket 24.

In some embodiments, the orientation-maintaining component 150 can include a bracket and/or flange, or another type of component, coupled to the first segment 140. In other embodiments, the orientation-maintaining component 150 can be unitary with the first segment 140. That is, the first segment 140 and orientation-maintaining component 150 can be formed as a single-piece construction. For example, the orientation-maintaining component 150 can include an integral projection, like a bent flange or shaped projection, that extends from the first segment 140.

In an embodiment, the orientation-maintaining component 150 can include one or more rotation enabling features like a chamfer 158 that permits rotation of the bracket 24 without binding against the orientation-maintaining component 150.

Referring again to FIG. 2, the impact of a vehicle in direction 58 disengages the arm 20 from the detent 92 (FIG. 3) of the bracket 24. The arm 20 is shown having been disengaged from the bracket 24 due to the impact of the vehicle while the arm 20 is in the lowered position. The orientation-maintaining component 150 maintains the forcing rod assembly 36 in alignment with the arm 20 during this breakaway condition.

The arm 20 can be reset from the second position 44 to the first position 42 by moving the arm 20 in the direction 126. More particularly, the user can push or pull the arm 20 in the direction 126 about the pivot connection 52. As the arm 20 reaches the first position 42, the arm 20 can interact with the detent 92 of the bracket 24. Once past the detent 92, the arm 20 is restored to the first position 42 and ready for normal use. The operator 10 can then raise and lower the arm 20 as if the breakaway condition never occurred. In this regard, the operator 10 allows for easy reset to mitigate the need for a service technician or other skilled laborer.

In some instances, the operator 10 can sense the breakaway condition and prevent use of the operator 10 to raise and/or lower the arm 20 during the breakaway condition. For example, the detector, e.g., the hall effect sensor 120, can detect the absence of the arm 20 and notify the processor 48. The processor 48 can prevent the drive 22 from engaging in response to receiving the notification from the detector, e.g., the hall effect sensor 120, thereby preventing movement of the arm 20. Once the arm 20 is restored to the first position 42, the detector, e.g., the hall effect sensor 120, can detect the arm 20 and notify the processor 48 which can resume normal operation.

Referring again to FIG. 1, the operator 10 has a controller 128 that is programmed with instructions, e.g., saved at the memory storage device 50, for causing movement of the arm 20 and other functions/operations. The controller 128 upon executing the instructions is operable to communicate with indicator light 18 and to communicate with an arm detection sensor, e.g., hall effect sensor 120, of the bracket 24. In other embodiments, the arm detection sensor may alternatively be a microswitch, accelerometer, gyroscope, etc. in communication with the controller 128. The drive 22 can include a motor and a gearbox, and the drive 22 receives communications or commands regarding arm position control and acts upon the communications by moving the bracket 24 and the arm 20 accordingly. The operator 10 further includes an encoder, such as an absolute position encoder ‘APE’, that communicates arm position information to the controller 128. In one embodiment, the encoder monitors movement of one or more components of the gearbox. The operator 10 further includes a counterbalance that provides a bias force against the torque applied by the arm 20 to the gearbox such that the counterbalance maintains the arm 20 in the lowered position until the motor is operated to raise the arm 20. The counterbalance reduces the torque of the motor to be applied to the arm 20 for moving the arm 20 between lowered and raised positions. The operator 10 can further include an alarm, such as an enunciator such as a speaker and/or light to indicate an alarm condition communicated from the controller 128. For example, when the arm detection sensor has detected that the arm 20 has been partially disengaged from the bracket 24, the controller 128 may cause a particular illumination (e.g., flashing, strobing, etc.) of the indicator light 18, as well as trigger an audible warning via a speaker of the alarm. As another example, when the operator 10 is automatically reengaging the arm 20 after the arm 20 has been struck by a vehicle, the controller 128 may operate a speaker of the alarm to emit a series of beeps as the controller 128 slowly operates the motor (i.e. at a speed that may be substantially slower than the motor would normally raise the arm 20 for permitting access therebeyond).

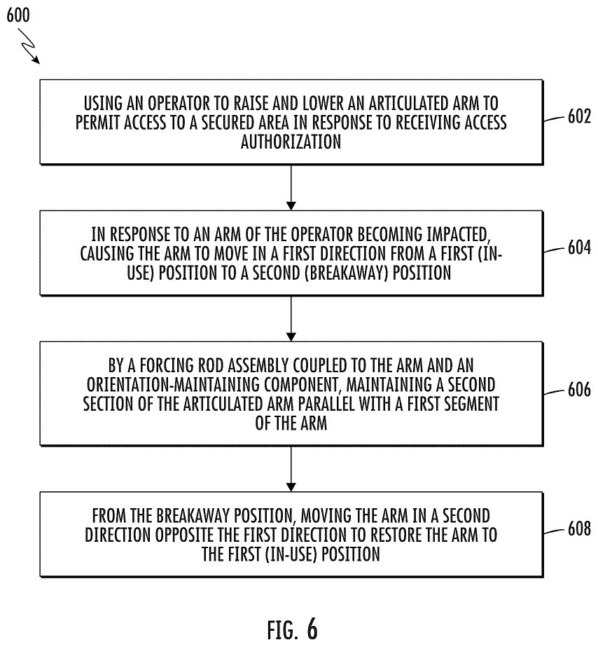

FIG. 6 is a flow chart of a method 600 of using an operator in accordance with an example embodiment. In general, the method 600 will be described with reference to a system including the operator 10 and arm 20 described above with reference to FIGS. 1 to 5. In addition, although FIG. 6 depicts steps performed in a particular order for purposes of illustration and discussion, the method discussed herein is not limited to any particular order or arrangement. One skilled in the art, using the disclosure provided herein, will appreciate that various steps of the method disclosed herein can be omitted, rearranged, combined, and/or adapted in various ways without deviating from the scope of the present disclosure.

The method 600 includes using 602 an operator (such as the operator 10) to raise and lower an articulated arm to permit access to a secured area in response to receiving access authorization. The secured area can include, for example, a gated community, a parking facility (such as a parking lot or a parking garage), a commercial environment, a residential environment, or the like. Authorization can be received automatically (or semi-automatically) when access credentials are determined to be present. Alternatively, or additionally, authorization can be performed manually, e.g., by a local parking attendant or security guard. In response to receiving the authorization, the operator can drive an arm, such as an articulated arm, to move from a lowered (blocking) position to a raised (access granted) position to allow access to the secured area. After entry is complete (or the entrant is sufficiently clear of the arm), the operator can return the arm to the lowered (blocking) position to restrict unauthorized access. This process can be repeated each time authorization is granted.

Using 602 the operator to grant access to the secured area by raising the arm can be performed using an underhand operator including a forcing rod assembly mounted to the arm at a vertical elevation below the arm when the arm is in the lowered (blocking) position. As described above, use of the underhand operator can allow for better height clearance in low clearance environments by removing hardware and other attachments and components from an upper side of the arm, thereby allowing the arm to raise further (to a higher maximum height) before hitting a height-restrictive article above the operator, such as a garage ceiling, a tunnel ceiling, a tree branch, a fiber optic or electrical wire, or the like. In this regard, vehicle clearance can be maximized, thus allowing relatively taller vehicles to access the secured area without requiring local personnel (such as a security guard) to move the arm into the breakaway condition to grant access.

The method 600 further includes during use of the operator, an arm of the operator becoming impacted, causing 604 the arm to move in a first direction from a first (in-use) position to a second (breakaway) position. An orientation-maintaining component can maintain 606 a forcing rod assembly in an orientation and/or position which restricts a second segment of the arm from sagging. In response to the breakaway condition, the method 600 further includes, from the breakaway position, moving 608 the arm in a second direction opposite the first direction restore the arm to the first (in-use) position.

Further aspects of the invention are provided by one or more of the following embodiments:

Embodiment 1. A barrier arm operator comprising: an operator comprising a drive and a bracket operably coupled to the drive, wherein the drive rotates the bracket about a rotational axis in a first direction and a second direction opposite the first direction; an arm coupled to the bracket and driven between a lowered position and a raised position by rotation of the bracket about the rotational axis, wherein the arm comprises a first arm segment coupled to the bracket and a second arm segment coupled to the first arm segment; and a forcing rod assembly coupled to the operator and coupled to the arm at a vertical elevation below the arm when the arm is in the lowered position, wherein the forcing rod assembly articulates the second arm segment relative to the first arm segment in response to the bracket rotating about the rotational axis, wherein the arm is rotatably coupled to the bracket about a pivot axis, and wherein the arm rotates about the pivot axis in response to impact from an object against the arm.

Embodiment 2. The barrier arm operator of embodiment 1, wherein the forcing rod assembly is oriented parallel to the first arm segment when the arm is in the lowered position and the raised position.

Embodiment 3. The barrier arm operator of embodiment 1, wherein the pivot axis is orthogonal to the rotational axis, and wherein the forcing rod assembly is oriented parallel to the first arm segment when the arm rotates about the pivot axis.

Embodiment 4. The barrier arm operator of embodiment 1, wherein the forcing rod assembly comprises: a first segment rotatably coupled to the operator about a rotational axis; and a second segment rotatably coupled to the first segment about a pivot axis oriented orthogonal to the rotational axis, wherein the rotational axis of the bracket is parallel to the rotational axis of the first segment, and wherein the pivot axis of the first arm is parallel to the pivot axis of the second segment of the forcing rod assembly.

Embodiment 5. The barrier arm operator of embodiment 4, wherein the forcing rod assembly comprises an orientation-maintaining component that maintains the forcing rod assembly substantially parallel to the first arm segment when the arm rotates about the pivot axis.

Embodiment 6. The barrier arm operator of embodiment 5, wherein the orientation-maintaining component comprises a flange coupled to the forcing rod assembly, wherein the flange interacts with the bracket to maintain the forcing rod assembly substantially parallel to the first arm segment.

Embodiment 7. The barrier arm operator of embodiment 6, wherein the flange is coupled to the forcing rod assembly at a location proximate to the rotational axis of the first arm.

Embodiment 8. The barrier arm operator of embodiment 6, wherein the flange comprises an opening, and wherein an axle extends through the opening, the axle forming the rotational axis upon which the first arm rotates.

Embodiment 9. The barrier arm operator of embodiment 5, wherein the orientation-maintaining component extends from the forcing rod assembly in an upward direction when the arm is in the lowered position.

Embodiment 10. The barrier arm operator of embodiment 1, wherein the second arm segment defines a highest location of the barrier arm operator when the arm is in the raised position.

Embodiment 11. The barrier arm operator of embodiment 1, wherein the barrier arm operator further comprises: a controller; an arm detection sensor configured to detect disengagement of the arm from the bracket; and an indicator, wherein the controller receives a signal from the arm detection sensor in response to the arm disengaging from the bracket, and wherein the controller causes the indicator to generate an alert in response to the received signal.

Embodiment 12. The barrier arm operator of embodiment 1, wherein the forcing rod assembly is coupled to the second arm segment through a connector, and wherein the connector extends down from the second arm segment to interface with the forcing rod assembly at a vertical elevation below the second arm segment when the arm is in the raised and lowered positions.

Embodiment 13. The barrier arm operator of embodiment 1, wherein the forcing rod assembly is coupled to the operator at a vertical elevation below the rotational axis of the bracket.

Embodiment 14. The barrier arm operator of embodiment 1, wherein a length of the forcing rod assembly is adjustable, and wherein adjusting the length of the forcing rod assembly changes an angle of the second arm segment of the arm with respect to a horizontal orientation in at least one of the lowered and raised positions.

Embodiment 15. The barrier arm operator of embodiment 1, wherein the second arm segment of the arm remains at a relatively constant angle with respect to a horizontal plane as the bracket rotates about the rotational axis.

Embodiment 16. The barrier arm operator of embodiment 1, wherein the forcing rod assembly passively rotates in response to rotation of the bracket about the rotational axis.

Embodiment 17. The barrier arm operator of embodiment 1, further comprising a processor coupled to a memory storing computer-readable instructions, wherein the processor controls the drive in response to one or more received signals.

Embodiment 18. A movable barrier assembly comprising: a barrier arm operator comprising: a housing; a driving mechanism supported by the housing; and a bracket coupled to the driving mechanism and driven to rotate about a rotational axis by the driving mechanism; a multi-segmented arm assembly movable between a lowered position and a raised position, the multi-segmented arm assembly comprising: a first arm segment coupled to the bracket; and a second arm segment coupled to the first arm segment at an articulation; and a forcing rod assembly that passively articulates the first arm segment relative to the second arm segment in response to rotation of the driving mechanism, wherein the forcing rod assembly is disposed at a vertical elevation below the arm when the arm is in the lowered position.

Embodiment 19. The movable barrier assembly of embodiment 18, wherein the forcing rod assembly is oriented parallel to the first arm segment when the multi-segmented arm assembly is in both the lowered position and the raised position.

Embodiment 20. The movable barrier assembly of embodiment 18, wherein the multi-segmented arm assembly and the forcing rod assembly are movable between an engaged position to selectively control access to a secured area and a breakaway position, and wherein the engaged position and the breakaway position are separated by an angular displacement about a pivot axis oriented perpendicular to the rotational axis.

Embodiment 21. The movable barrier assembly of embodiment 20, further comprising a flange coupled to the forcing rod assembly, wherein the flange maintains the forcing rod assembly substantially parallel to the first arm segment when the multi-segmented arm assembly moves from the engaged position to the breakaway position.

Embodiment 22. The movable barrier assembly of embodiment 18, wherein the second arm segment defines a highest location of the movable barrier assembly when the multi-segmented arm assembly is in the raised position, and wherein the entire forcing rod assembly is spaced apart vertically below the highest location.

Embodiment 23. A movable barrier arm assembly comprising: a multi-segmented arm assembly configured to move between a raised position and a lowered position, the multi-segmented arm assembly comprising: a first arm segment; and a second arm segment coupled to the first arm segment at an articulation; and a forcing rod assembly configured to passively articulate the first arm segment relative to the second arm segment in response to the first arm segment being rotationally driven about a rotational axis by a driving mechanism of a barrier arm operator, wherein the forcing rod assembly is disposed at a vertical elevation below the multi-segmented arm assembly when the multi-segmented arm assembly is in the lowered position.

Embodiment 24. The movable barrier arm assembly of embodiment 23, further comprising a flange coupled to the forcing rod assembly, wherein the flange maintains the forcing rod assembly substantially parallel to the first arm segment when the multi-segmented arm assembly moves from an engaged position to selectively control access to a secured area to a breakaway position, and wherein the engaged position and the breakaway position are separated by an angular displacement about a pivot axis oriented perpendicular to the rotational axis.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B”is intended to encompass A, B, or both A and B.

While there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. A movable barrier assembly comprising:
a barrier arm operator comprising:
a housing;
a driving mechanism supported by the housing; and
a bracket coupled to the driving mechanism and driven to rotate about a rotational axis by the driving mechanism;
a multi-segmented arm assembly movable between a lowered position and a raised position, the multi-segmented arm assembly comprising:
a first arm segment coupled to the bracket; and
a second arm segment coupled to the first arm segment at an articulation; and
a forcing rod assembly that passively articulates the first arm segment relative to the second arm segment in response to rotation of the driving mechanism, wherein the forcing rod assembly is disposed at a vertical elevation below the arm when the arm is in the lowered position.

2. The movable barrier assembly of claim 1, wherein the forcing rod assembly is oriented parallel to the first arm segment when the multi-segmented arm assembly is in both the lowered position and the raised position.

3. The movable barrier assembly of claim 1, wherein the multi-segmented arm assembly and the forcing rod assembly are movable between an engaged position to selectively control access to a secured area and a breakaway position, and wherein the engaged position and the breakaway position are separated by an angular displacement about a pivot axis oriented perpendicular to the rotational axis.

4. The movable barrier assembly of claim 3, further comprising a flange coupled to the forcing rod assembly, wherein the flange maintains the forcing rod assembly substantially parallel to the first arm segment when the multi-segmented arm assembly moves from the engaged position to the breakaway position.

5. The movable barrier assembly of claim 1, wherein the second arm segment defines a highest location of the movable barrier assembly when the multi-segmented arm assembly is in the raised position, and wherein the entire forcing rod assembly is spaced apart vertically below the highest location.

6. A movable barrier assembly comprising:
an operator comprising:
a driving mechanism; and
a bracket operably coupled to the driving mechanism,
wherein the driving mechanism rotates the bracket about a rotational axis in a first direction and a second direction opposite the first direction;
an arm coupled to the bracket and driven between a lowered position and a raised position by rotation of the bracket about the rotational axis, wherein the arm comprises:
a first arm segment coupled to the bracket; and
a second arm segment coupled to the first arm segment; and
a forcing rod assembly coupled to the operator and coupled to the arm at a vertical elevation below the arm when the arm is in the lowered position, wherein the forcing rod assembly articulates the second arm segment relative to the first arm segment in response to the bracket rotating about the rotational axis, wherein the arm is rotatably coupled to the bracket about a pivot axis, and wherein the arm rotates about the pivot axis in response to impact from an object against the arm.

7. The movable barrier assembly of claim 6, wherein the forcing rod assembly is oriented parallel to the first arm segment when the arm is in both the lowered position and the raised position.

8. The movable barrier assembly of claim 6, wherein the pivot axis is orthogonal to the rotational axis, and wherein the forcing rod assembly is oriented parallel to the first arm segment when the arm rotates about the pivot axis.

9. The movable barrier assembly of claim 6, wherein the forcing rod assembly comprises:
a first segment rotatably coupled to the operator about a rotational axis; and
a second segment rotatably coupled to the first segment about a pivot axis oriented orthogonal to the rotational axis,
wherein the rotational axis of the bracket is parallel to the rotational axis of the first segment, and wherein the pivot axis of the first arm is parallel to the pivot axis of the second segment of the forcing rod assembly.

10. The movable barrier assembly of claim 9, wherein the forcing rod assembly comprises an orientation-maintaining component that maintains the forcing rod assembly substantially parallel to the first arm segment when the arm rotates about the pivot axis.

11. The movable barrier assembly of claim 10, wherein the orientation-maintaining component comprises a flange coupled to the forcing rod assembly, wherein the flange interacts with the bracket to maintain the forcing rod assembly substantially parallel to the first arm segment.

12. The movable barrier assembly of claim 11, wherein the flange is coupled to the forcing rod assembly at a location proximate to the rotational axis of the first arm.

13. The movable barrier assembly of claim 6, wherein the second arm segment defines a highest location of the movable barrier assembly when the arm is in the raised position, and wherein the entire forcing rod assembly is spaced apart vertically below the highest location.

14. The movable barrier assembly of claim 6, wherein the operator further comprises:
a controller;
an arm detection sensor configured to detect disengagement of the arm from the bracket; and
an indicator,
wherein the controller receives a signal from the arm detection sensor in response to the arm disengaging from the bracket, and wherein the controller causes the indicator to generate an alert in response to the received signal.

15. The movable barrier assembly of claim 6, wherein the forcing rod assembly is coupled to the second arm segment through a connector, and wherein the connector extends down from the second arm segment to interface with the forcing rod assembly at a vertical elevation below the second arm segment when the arm is in the raised and lowered positions.

16. The movable barrier assembly of claim 6, wherein the forcing rod assembly is coupled to the operator at a vertical elevation below the rotational axis of the bracket.

17. The movable barrier assembly of claim 6, wherein a length of the forcing rod assembly is adjustable, and wherein adjusting the length of the forcing rod assembly changes an angle of the second arm segment of the arm with respect to a horizontal orientation in at least one of the lowered and raised positions.

18. The movable barrier assembly of claim 6, wherein the second arm segment of the arm remains at a relatively constant angle with respect to a horizontal plane as the bracket rotates about the rotational axis.

19. A movable barrier arm assembly comprising:
a multi-segmented arm assembly configured to move between a raised position and a lowered position, the multi-segmented arm assembly comprising:
a first arm segment; and
a second arm segment coupled to the first arm segment at an articulation; and
a forcing rod assembly configured to passively articulate the first arm segment relative to the second arm segment in response to the first arm segment being rotationally driven about a rotational axis by a driving mechanism of a barrier arm operator, wherein the forcing rod assembly is disposed at a vertical elevation below the multi-segmented arm assembly when the multi-segmented arm assembly is in the lowered position.

20. The movable barrier arm assembly of claim 19, further comprising a flange coupled to the forcing rod assembly, wherein the flange maintains the forcing rod assembly substantially parallel to the first arm segment when the multi-segmented arm assembly moves from an engaged position to selectively control access to a secured area to a breakaway position, and wherein the engaged position and the breakaway position are separated by an angular displacement about a pivot axis oriented perpendicular to the rotational axis.
